(19) United States
(12) Patent Application Publication
(10) Pub. No.: US 2025/0038620 A1
(43) Pub. Date: Jan. 30, 2025

(54) ROTOR SHAFT FOR AN ELECTRIC MOTOR, ASSEMBLY FOR A ROTOR SHAFT, AND METHOD FOR MANUFACTURING AN ASSEMBLY FOR A ROTOR SHAFT

(71) Applicant: MTU Aero Engines AG, München (DE)

(72) Inventors: Martin Schloffer, Pähl (DE); Johann Goebel, Munich (DE)

(73) Assignee: MTU Aero Engines AG, München (DE)

(21) Appl. No.: 18/707,472

(22) PCT Filed: Nov. 7, 2022
(86) PCT No.: PCT/DE2022/100818

§ 371 Date: May 3, 2024

(30) Foreign Application Priority Data
Nov. 12, 2021 (DE) 10 2021 129 618.8

(51) Int. Cl. H02K 9/19; B64D 33/08; H02K 7/00

(52) U.S. Cl. CPC H02K 9/19; B64D 33/08; H02K 7/003

(57) ABSTRACT

The invention relates to a rotor shaft for an electric motor, in particular for an aircraft engine, wherein the rotor shaft has a forged attachment flange, wherein the attachment flange is provided for attachment to another shaft in order to transmit a force and/or a torque, comprises a first axial end facing the other shaft, and comprises a base plate on a second axial end opposite the first axial end. It is provided that the rotor shaft has a coolant distribution body that is additively manufactured at least in some regions, wherein the additively manufactured coolant distribution body is arranged on the base plate of the forged attachment flange in a radially centered manner, and the rotor shaft has a rotor device, which radially surrounds the additively manufactured coolant distribution body and is joined to the base plate of the forged attachment flange at least in a force-fitting manner.

### BACKGROUND OF THE INVENTION

The invention relates to a rotor shaft for an electric motor, in particular for an aircraft engine, in accordance with an assembly for a rotor shaft and a method for manufacturing an assembly for a rotor shaft in accordance with the present invention.

Electric motors comprise a stator and a rotor. The rotor of the electric motor is hereby arranged on a rotor shaft. During operation of the electric motor, the rotor of the electric motor rotates and the torque induced in the rotor is transmitted via the rotor shaft to a gearbox. In order to be able to transmit the torque to a gearbox, rotor shafts have a rotor flange in a front region, on which a gearbox shaft can be arranged. In designing the respective rotor shaft, it needs to be made sure that the rotor shaft is sufficiently stable to transmit the toque supplied by the rotor. In order to be able to transmit the supplied torque, the rotor flange and the rotor shafts in the megawatt and gigawatt range are manufactured from forged alloys. In these ranges of power, it may be necessary to cool the rotor by supplying coolant. The supply of coolant can occur, for example, through the rotor shaft. For this purpose, it is necessary to arrange coolant channels in the rotor shaft that are able to deliver the coolant to the rotor and drain the coolant from the rotor.

However, the channel structure formed by the coolant channels can entail a complexity that cannot be realized by means of forged rotor shafts.

A possibility of manufacturing rotor shafts with complex cooling channel structures consists in manufacturing the rotor shafts by means of additive manufacturing methods. A drawback of additively manufactured rotor shafts is their lower ability to withstand mechanical loads in comparison to forged rotor shafts. As a result, additively manufactured rotor shafts cannot meet certain safety standards for rotor shafts.

However, a use of forged rotor shafts with simpler cooling channel structures would diminish the cooling capacity, as a result of which the power density of the electric motor would be reduced.

EP 3 580 434 A1 discloses parts and a method for producing parts by use of additive manufacturing methods. The method discloses a use of an additive manufacturing method on a base substrate of a component. It is hereby possible for an annular part of the component to be applied additively to a base part of the component. The annular part of the component can be formed in such a way that it has material properties that differ from those of the base part of the component.

Disclosed in US 2016/0010469 A1 is a method for manufacturing a rotor. The method for producing the rotor comprises a fabrication of a hub by using a conventional manufacturing method and the fabrication of a blade or vane on the hub by means of a layer-by-layer additive manufacturing method.

EP 2 772 329 A1 discloses a method for manufacturing a hybrid component. In the method, it is provided that a preform is fabricated as a first part of the hybrid component, A second part of the component made of a metallic powdered material is then applied to the preform by successive buildup by means of an additive manufacturing method.

Described in EP 3 840 197 A1 is a method for producing a rotor for a generator. In the method, it is provided that at least one part of a rotor shaft is fabricated by way of a three-dimensional (3D) printing method. The step of printing a rotor core comprises the printing of a plurality of liquid coolant lines that extend through the rotor core.

EP 3 654 501 A1 discloses an additively formed rotor component for an electric machine and a method for manufacturing the additively formed rotor component. The formed rotor component can comprise a rotor assembly or a rotor shaft. A first part of the rotor shaft can be printed, for example, by means of additive manufacturing methods. A second part of the rotor shaft can be formed centrally within a rotor core. Cooling tubes can be formed all the way through parts of the rotor core in a uniform manner. The cooling tubes can be printed by additive manufacturing in each layer of the rotor core. The cooling tubes can define cooling holes.

A problem of the invention is to provide a rotor shaft that makes possible a required cooling of a rotor and, at the same time, has a requisite stability for the transmission of a predetermined torque.

### SUMMARY OF THE INVENTION

In accordance with the invention, the problem is solved by a rotor shaft for an electric motor, in particular for an aircraft engine, in accordance with the features of an assembly for a rotor shaft and a method for manufacturing an assembly for a rotor shaft in accordance with the present invention. Advantageous embodiments with appropriate further developments of the invention are specified in the respective dependent claims, whereby advantageous embodiments of each aspect of the invention are to be regarded as advantageous embodiments of the other respective aspects of the invention.

A first aspect of the invention relates to a rotor shaft for an electric motor, in particular for an aircraft engine. In other words, the rotor shaft can be provided for a use in an electric motor, which, in particular, can be designed as an aircraft engine. It is provided that the rotor shaft has a forged attachment flange. The attachment flange can be cast or else produced by powder metallurgy and forged. In other words, the attachment flange is fabricated by a casting method or by a powder metallurgical method and a forging method. The attachment flange is provided for attachment to another shaft in order to transmit a force and/or a torque. In other words, the attachment flange is designed for attachment to another shaft. The other shaft can involve a gearbox shaft to which the supplied torque of the electric motor is to be transmitted. The attachment flange has a first axial end, which is to be aligned in the direction of the other shaft. Accordingly, the first axial end can be axially facing the other shaft. On a second axial end opposite the first axial end, the attachment flange has a base plate. In other words, the attachment flange is bounded on the second axial end by the base plate.

The invention provides that the rotor shaft has a coolant distribution body that is additively manufactured at least in some regions, wherein the coolant distribution body that is additively manufactured at least in some regions is arranged on the base plate of the forged attachment flange in a radially centered manner. In other words, a coolant distribution body that is axially centered on the base plate and is fabricated by an additive manufacturing method at least in some regions is situated on the attachment flange. The additively manufactured coolant distribution body can be arranged on the base plate of the attachment flange in a force-fitting, form-fitting, or material-bonded manner. The coolant distribution body can have a cylindrical shape and, like the attachment flange, extend in a centered manner along a longitudinal axis of the rotor shaft.

The rotor shaft has a rotor device, which radially surrounds the additively manufactured coolant distribution body and which is joined to the base plate of the forged attachment flange at least in a force-fitting manner, in particular directly in a force-fitting manner. In other words, the additively manufactured coolant distribution body is surrounded along its outer surface by the rotor device. The rotor device can rest, for example, against the outer surface of the coolant distribution body. The rotor device can have coils and cores, which, during operation, can be cooled by a coolant supplied via the coolant distribution body. The coolant distribution body is hereby set up in such a way that it can deliver the coolant to the rotor device or drain it from the rotor device. In order to reduce any load placed on the coolant distribution body owing to the torque that is to be transmitted, the rotor device can be joined to the base plate of the forged attachment flange at least in a force-fitting manner. In this way, it is possible for the torque induced in the rotor device, in particular directly and/or indirectly, to be transmitted to the base plate and/or via the base plate in the attachment flange. In that a transmission of the torque occurs via the base plate, the mechanical load placed on the coolant distribution body is reduced, so that the coolant distribution body needs to have a lower mechanical stability than would be required in the case of a sole transmission of the torque via the coolant distribution body.

The invention affords the advantage that it is made possible to use a coolant distribution body that is additively manufactured at least in some regions, because the produced torque is transmitted for the most part to the base plate of the attachment flange.

A further development of the invention provides that, on the first axial end, the attachment flange has a mount for mounting the other shaft. In other words, the attachment flange is set up for mounting the other shaft on the mount of the attachment flange. The mount is situated on the first axial end of the attachment flange.

A further development of the invention provides that the rotor shaft comprises an external attachment element, which is set up to join the attachment flange to the other shaft. The external attachment element can be designed to make possible an external attachment of the attachment flange to the other shaft. The external attachment element can be designed to make possible a force-fitting and/or form-fitting connection to the attachment flange in order to transmit a force and/or a torque from the attachment flange to the other shaft via the external attachment element. The external attachment element can be designed, for example, for force-fitting and/or form-fitting attachment to the mount or to the attachment flange. In addition, the external attachment element can be designed, for example, for force-fitting and/or form-fitting attachment to the other shaft.

A further development of the invention provides that the coolant distribution body that is additively manufactured at least in some regions has coolant channels that are in fluidic connection with channel openings on an outer surface of the coolant distribution body that is additively manufactured at least in some regions. In other words, the coolant distribution body has cooling channels that are set up to carry the coolant through the coolant distribution body. The channel openings are set up to make possible a delivery of the coolant to the rotor device and a draining of the coolant out of the rotor device.

A further development of the invention provides that the coolant distribution body that is additively manufactured at least in some regions comprises an axially extending coolant delivery element at an end facing away from the attachment flange. In other words, the coolant delivery element, which extends axially along the shaft axis, is situated at an end of the coolant distribution body lying axially opposite the attachment flange. The coolant delivery element can have a delivery line and a draining line in order to make possible a delivery of the coolant to the coolant distribution body and a draining of the coolant out of the coolant distribution body.

A further development of the invention provides that at least some of the coolant channels are in fluidic connection with a cooling channel of the attachment flange. In other words, the attachment flange has at least one cooling channel that is in fluidic connection with at least one cooling channel of the coolant distribution body. This affords the advantage that the coolant can also be delivered to the attachment flange.

A further development of the invention provides that the rotor device is joined to the attachment flange through a connection device. In other words, the rotor shaft has the connection device, which is set up to connect the rotor device to the attachment flange in such a way that a direct transmission of the torque from the rotor device onto the attachment flange is made possible. For example, the connection device can produce, in particular, a direct and/or indirect force-fitting, form-fitting, and/or material-bonded connection between the rotor device and the attachment flange.

A further development of the invention provides that the connection device has first tie rods, which are anchored in the rotor device and the attachment flange. In other words, the connection device comprises the first tie rods, with a respective one of the first tie rods being anchored both in the rotor device and in the attachment flange. This affords the advantage that, via the first tie rods, a transmission of the torque induced in the rotor device onto the attachment flange is made possible.

A further development of the invention provides that the rotor device comprises a rotor unit, which is arranged axially between two flange plates, with the two flange plates being joined to each other through second tie rods. In other words, the rotor device comprises the rotor unit. The rotor unit can have, for example, the coils and the cores of the rotor. Situated on the axial ends of the rotor device are the two flange plates, which, for example, can be forged. In order to join the flange plates to each another and the flange plates to the rotor unit, the rotor device has the second tie rods, each of which can be anchored in the two flange plates.

A further development of the invention provides that the coolant distribution body is applied additively on the attachment flange in a material-bonded manner. In other words, it is provided that the at least partly additively manufactured coolant distribution body is applied additively onto the attachment flange, so that a material-bonded connection between the attachment flange and the coolant distribution body is created. The further development affords the advantage that an especially stable mechanical connection between the attachment flange and the coolant distribution body is provided.

A second aspect of the invention relates to an assembly for a rotor shaft. The assembly comprises a forged attachment flange, wherein the attachment flange is provided for attachment to another shaft in order to transmit a force and/or a torque. In other words, the attachment flange is designed for attachment to another shaft. The other shaft can involve a gearbox shaft, to which the supplied torque of the electric motor is to be transmitted. The attachment flange has a first axial end, which is to be aligned in the direction of the other shaft. Accordingly, the first axial end can be axially facing the other shaft. On a second axial end that lies opposite the first axial end, the attachment flange has a base plate. In other words, the attachment flange is bounded on the second axial end by the base plate.

It is provided that the rotor shaft has a coolant distribution body that is additively manufactured at least in some regions, with the additively manufactured coolant distribution body being arranged on the base plate of the forged attachment flange of the assembly in a radially centered manner.

Further features and the advantages thereof may be taken from the descriptions of the first aspect of the invention.

A third aspect of the invention relates to a method for manufacturing an assembly for a rotor shaft. In the method, it is provided that, on a forged attachment flange, which comprises a base plate, a coolant distribution body is applied in accordance with a predetermined additive manufacturing method. The coolant distribution body is hereby arranged on the base plate of the forged attachment flange in a radially centered manner.

Further features and the advantages thereof may be taken from the descriptions of the first and second aspects of the invention.

### BRIEF DESCRIPTION OF THE DRAWING FIGURES

Further features of the invention ensue from the claims, the figures, and the description of the figures. The features and combinations of features mentioned above in the description as well as the features and combination of features shown below in the description of the figures and/or solely in the figures can be used not only in the respectively specified combination, but also in other combinations, without leaving the scope of the invention. Accordingly, embodiments of the invention that are not explicitly shown and explained in the figures, but can be derived and produced from the explained embodiments through separate combinations of features, are also to be regarded as comprised and disclosed. Also to be regard as disclosed are embodiments and combinations of features that, accordingly, do not have all features of an independent claim as originally formulated. Beyond this, embodiments and combinations of features, in particular through the embodiments discussed above, that go beyond the combinations of features discussed with reference back to the claims or depart from them are to be regarded as disclosed. Shown are:

FIG. 1 a schematic illustration of a rotor shaft according to the invention for an electric motor;

FIG. 2 a schematic illustration of an assembly according to the invention for a rotor shaft; and

FIG. 3 a schematic illustration of a method according to the invention for manufacturing an assembly for a rotor shaft.

### DESCRIPTION OF THE INVENTION

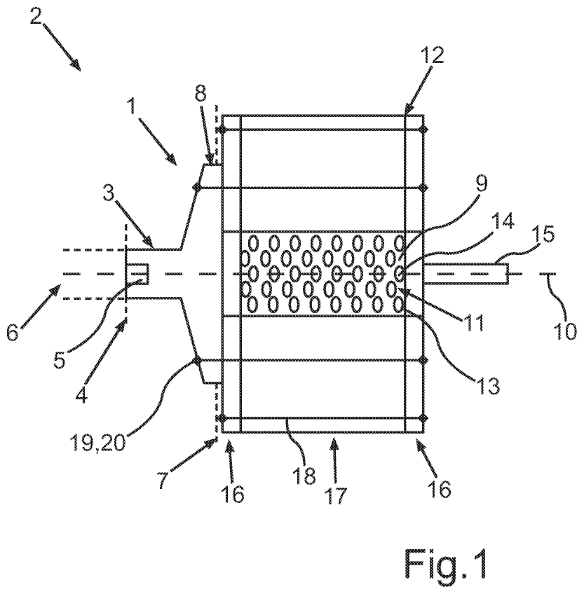

FIG. 1 shows a schematic illustration of a rotor shaft for an electric motor. The rotor shaft 1 can be provided, in particular, for the electric motor 2 of an aircraft engine. The rotor shaft 1 can have a forged attachment flange 3, which can be fabricated in accordance with a predetermined forging method from a titanium alloy, for example. On a first axial end 4, the attachment flange 3 can have a mount 5 for mounting another shaft 6, such as, for example, a gearbox shaft. The first axial end 4 can face the other shaft 6. On a second axial end 7, the attachment flange 3 can have a base plate 8. The attachment flange 3 can be provided to transmit the torque of the rotor shaft 1 to the other shaft 6.

Alternatively or additionally to the mount 5, in an embodiment that is not shown, the rotor shaft can comprise an external attachment element (not shown), which is set up to join the attachment flange 3 to the other shaft 6. The external attachment element can be designed to make possible an external attachment of the attachment flange 3 to the other shaft 6 as, for example, an attachment section of the other shaft 6 that externally surrounds the attachment flange 3 and/or in which the attachment flange 3 is mounted. The external attachment element can be designed to make possible a direct or indirect force-fitting and/or form-fitting connection between the attachment flange 3 and the other shaft 6 in order to transmit a force and/or a torque from the attachment flange 3 to the other shaft 6 via the external attachment element. The external attachment element can be a section of the other shaft 6 or can be formed integrally and in one piece with it (direct connection) or else the external attachment element can be an additional or separate part (indirect connection) of the other shaft 6 and the attachment flange 3. The other shaft 6 can also be directly or indirectly connected to the attachment flange 3, as a result of which a direct or indirect transmission of the force or of the torque can be made possible.

An additively manufactured coolant distribution body 9 can be arranged on the attachment flange 3 and, like the attachment flange 3, can be arranged in a centered manner around a longitudinal axis 10 of the rotor shaft 1. The at least partly additively manufactured coolant distribution body 9 can have a cylindrical shape, which can extend along the longitudinal axis 10 of the rotor shaft 1. The at least partly additively manufactured coolant distribution body 9 can be joined to the attachment flange 3 in a force-fitting, form-fitting, or material-bonded manner. The coolant distribution body 9 can be applied directly by means of a predetermined additive manufacturing method, for example, onto the attachment flange 3 serving as a substrate and, for example, can be fabricated from a titanium alloy. Through the use of an additive manufacturing method, it is possible in the coolant distribution body 9 to provide coolant distribution body coolant channels 11, which can be set up to deliver a coolant supplied to the coolant distribution body 9 into a rotor device 12 or to drain it from the rotor device 12. To this end, the individual coolant channels 11 can be in fluidic connection with openings 13, which can be situated on an outer surface 14 of the coolant distribution body 9. In order to deliver the coolant to or drain it from the coolant distribution body 9, the coolant distribution body 9 can have a coolant supply element 15, which can be situated on a side of the coolant distribution body 9 that faces away from the base plate 8. The coolant delivery element 15 can have two channels, for example, in order to deliver or drain the coolant. The coolant distribution body 9 can be surrounded by the rotor device 12 at least radially. The rotor device 12 can have coil cores, which are cooled by the coolant carried through the coolant distribution body 9. The rotor device 12 can rest, for example, against the outer surface 14 of the coolant distribution body 9.

On account of the additive manufacturing method, the coolant distribution body 9 has a lower mechanical stability than forged components of the rotor shaft. Therefore, it may be necessary to design the rotor shaft 1 in such a way that the torque is transmitted in a different way from the rotor device 12 onto the attachment flange 3. For this purpose, the rotor device 12 can have flange plates 16, which can be arranged on axially opposite-lying sides of the rotor unit 17. The flange plates 16 can consist of forged titanium. The two flange plates 16 can be joined to each other through second tie rods 18, which can be anchored in the respective flange plates 16. The second tie rods 18 can be joined to the rotor unit 17 in order to connect the functional part of the rotor device 12 in a torque-transmitting manner to the flange plates 16. As connection device 19 for the transmission of the torque from the rotor device 12 onto the attachment flange 3, the rotor shaft 1 can have first tie rods 20, each of which can be anchored in at least one of the flange plates 16 and in the attachment flange 3. In this way, it is possible for the power supplied by the rotor device 12 to be transmitted directly to the attachment flange 3, so that the portion of the torque to be transmitted through the coolant distribution body 9 is reduced.

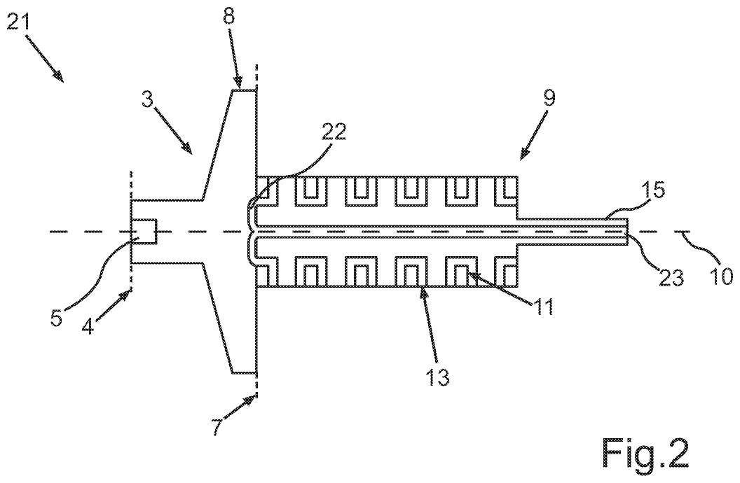

FIG. 2 shows a schematic illustration of an assembly for a rotor shaft. The assembly 21 can have an attachment flange 3, which can be fabricated in accordance with a forging method. The attachment flange 3 can consist of a titanium alloy, for example. On a first axial end 4, the attachment flange 3 can have a mount 5 for the arrangement of another shaft 6, which is not shown in the figure. On a second axial end 7 of the attachment flange 3, the attachment flange 3 can have a base plate 8. The attachment flange 3 can have coolant channels 22, which can be arranged on the second axial end. The coolant distribution body 9 can be at least partly additively manufactured and hereby applied onto the attachment flange 3 in a material-bonded manner. The coolant distribution body 9 can likewise consist of a titanium alloy. It can be provided that the coolant distribution body 9 is applied onto the attachment flange 3 in such a manner that coolant channels 11 of the coolant distribution body 9 can be in fluidic connection with the coolant channels 22 of the attachment flange 3. The coolant channels 11 of the coolant distribution body 9 can be in fluidic connection with openings 13 of the coolant distribution body 9, so that coolant from the coolant distribution body 9 can be delivered into the rotor device and discharged from it. In order to make possible a delivery and discharge of coolant in the coolant distribution body 9, the coolant distribution body 9 can have a coolant supply element 15, which, for example, can have two main channels 23 for delivery and discharge of the coolant.

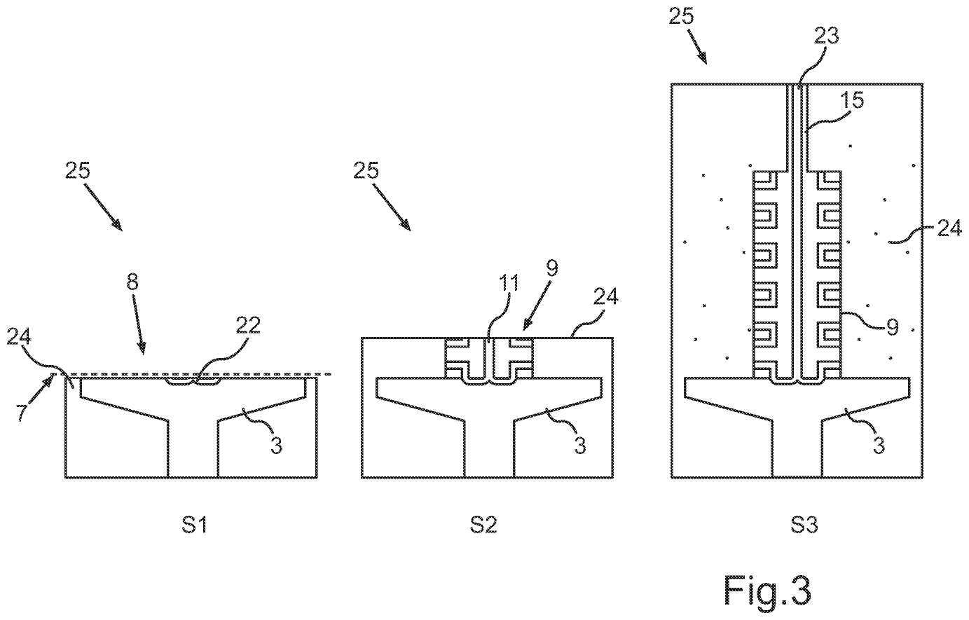

FIG. 3 shows a schematic illustration of a method for manufacturing an assembly. In a first step S1 of the method, a forged attachment flange 3 is arranged in a powder bed 24 of an additive manufacturing device 25. The attachment flange 3 can be arranged in such a way that the base plate 8 arranged on a second axial end 7 is aligned horizontally. Openings of the coolant channels 22 of the attachment flange 3 can lie in the horizontally aligned base plate 8.

In a second method step S2 of the method, a coolant distribution body 9 can be applied onto the attachment flange by means of an additive manufacturing method. The attachment flange 3 can hereby be a substrate of the coolant distribution body 9. It can also be provided that powder is applied layer by layer and heated locally along a joining zone. The layer-by-layer application can occur in such a way that a predetermined structure consisting of coolant channels 11 of the coolant distribution body 9 can be provided.

In a third step S3 of the method, for example, a coolant supply element 15 can be arranged on the coolant distribution body 9 additively or by means of a forged element.

Because the rotor shaft 1 has to transmit the entire power of the new electric motor to the gearbox, the motor flange, which is also referred to as an attachment flange 3, the frontmost part the rotor shaft, is subjected to very high loads, whereas the other regions of the rotor shaft 1 are less subject to loads in comparison. However, the latter could be or have to be furnished with a complex cooling structure in the coolant distribution body 9 in order to be able to attain the targeted power density. The solidly designed attachment flange 3 necessitates, however, a substantial effort in terms of time in additive manufacturing, entailing the risk of greater required time, longer scan lengths, larger melt surfaces, and flaws that are difficult to detect in the interior on account of the larger wall thickness. For economic reasons, such simple attachment flange geometries are to be produced classically via conventional methods in a more secure and economical manner and then to be joined to the additive shaft part with the cooling structure, which cannot be produced by conventional means.

It can be provided that the rotor shaft 1 comprises the front attachment flange 3, a flange plate 16, a coolant distribution body 9, a back flange plate 16, and a coolant supply element 15 via which the cooling medium can be delivered and drained, as shown in FIG. 1.

The rotor unit 17 of the electric motor can be clamped between the front and back flange plates 16 through second tie rods. In the attachment flange 3, the force is introduced from the clamped motor unit via long, first tie rods. Additionally, the attachment flange can be joined in a force-fitting and/or form-fitting manner to the flange plates 16.

Furthermore, during upscaling of the motor concept into the megawatt and gigawatt range, there exists the risk that the additively achieved material properties will not attain the high safety standards for safety-relevant attachment flanges 3. However, it is not possible to realize the rotor shaft 1 completely from forged material on account of the complex inner cooling. Losses of power on account of lower cooling capacity would be the consequence. An increase in weight and a drastic drop in power density of the entire system could make the propulsion system untenable.

In order to keep the front attachment flange 3 scalable into the megawatt or gigawatt range on account of higher loads or larger dimensions, it can be produced from forged Ti64, for example, as a present-day engine disc and so, too, the two flange plates 16. In this way, it is possible to transmit very high mechanical loads securely and to use further the nowadays usual design concept for shaft attachments.

In order to be join securely the attachment flange to the coolant distribution body that is additively manufactured in its entirety or at least in some regions, these two parts can be joined in a form-fitting, force-fitting, or material-bonded manner. The form-fitting connection can be produced by a bayonet fitting, the force-fitting connection by a thread, or the material-bonded connection by welding, soldering, or additive manufacturing.

A preferred variant of the material-bonded connection involves, for example, employing the forged, heat-treated, and nearly finished processed attachment flange in an additive manufacturing unit in such a way that, on the already partly pre-manufactured coolant channels, which are still opened upward, it is possible to build up additively the complex coolant distributor directly in the SLM or EBM powder bed process, for example.

In this way, a “composite” shaft unit made of a forged Ti64 rotor attachment flange, for example, and an additively manufactured Ti64 coolant distributor, for example, which cannot be fabricated conventionally in one piece, is formed.

Through the separate fabrication of the rotor attachment flange via forging, it is possible to realize the safety class 1. Through the subsequent additive manufacturing that builds thereupon directly, it is possible to realize complex structures of the coolant distributor within the same shaft. Such a part is not available conventionally and combines key advantages of both shafts. The established forging process is well tested for attachment flanges and is also more cost-effective for higher unit numbers. A fabrication of the attachment flange in the additive process is unattractive on account of the lower complexity. The production of more complex functional coolant channels in the structurally less loaded region of the shaft, which are important for competitive advantage and economy, however, is made possible by the additive manufacturing. Because, in general, such structures cannot be produced conventionally in optimized form, additive manufacturing is here the means of choice and is able to realize its strengths and functionalities with thin complex structures. In the case of small rotors in the 600-kW range, the use of this manufacturing concept makes it possible to realize already an advantage in terms of time in the additive manufacturing method (even should the mechanical properties be inadequate) and, later during upscaling, the hub can be calculated and designed using the existing Ti64-forged design data and very large constructions with wall thicknesses that are not producible economically and then would require new constructions can be realized. Accordingly, only constructions that, additively, have an advantage are built up additively. All other parts are fabricated conventionally with high-value mechanical properties, which is also more economical.

Overall, the invention makes it possible to provide a cooling of the rotor device while meeting the mechanical demands.

1. A rotor shaft for an electric motor for an aircraft engine, comprising:
a rotor shaft having a forged attachment flange, wherein the attachment flange is provided for attachment to another shaft to transmit a force and/or a torque, includes a first axial end facing the other shaft, and includes a base plate on a second axial end opposite the first axial end,
wherein the rotor shaft has a coolant distribution body that is additively manufactured at least in some regions, wherein the additively manufactured coolant distribution body is arranged on the base plate of the forged attachment flange in a radially centered manner, and
wherein the rotor shaft has a rotor device, which radially surrounds the additively manufactured coolant distribution body and is joined to the base plate of the forged attachment flange at least in a force-fitting manner.

2. The rotor shaft according to claim 1, wherein the attachment flange comprises, on the first axial end, a mount for mounting the other shaft.

3. The rotor shaft according to claim 1, wherein the rotor shaft comprises an external attachment element, which joins the attachment flange to the other shaft in a force-fitting and/or form-fitting manner.

4. The rotor shaft according to claim 1, wherein the coolant distribution body that is additively manufactured at least in some regions has coolant channels are in fluidic connection with channel openings on an outer surface of the coolant distribution body that is additively manufactured at least in some regions.

5. The rotor shaft according to claim 1, wherein the coolant distribution body that is additively manufactured at least in some regions comprises an axially extending coolant supply element on an end facing away from the attachment flange.

6. The rotor shaft according to claim 4, wherein at least some of the coolant channels are in fluidic connection with a cooling channel of the attachment flange.

7. The rotor shaft according to claim 1, wherein the rotor device is joined to the attachment flange through a connection device.

8. The rotor shaft according to claim 7, wherein the connection device has first tie rods, which are anchored in the rotor device and the attachment flange.

9. The rotor shaft according to claim 1, wherein the rotor device comprises a rotor unit, which is arranged axially between two flange plates, wherein the two flange plates are joined to each other by second tie rods.

10. The rotor shaft according to claim 1, wherein the coolant distribution body is applied additively onto the attachment flange in a material-bonded manner.

11. An assembly for a rotor shaft, comprising:
a forged attachment flange, wherein the attachment flange is configured and arranged for attachment to another shaft to transmit a force and/or a torque, comprises an axial end facing the other shaft, and comprises a base plate on a second axial end opposite the first axial end,
wherein the rotor shaft has a coolant distribution body that is additively manufactured at least in some regions, wherein the additively manufactured coolant distribution body is arranged on the base plate of the forged attachment flange in a radially centered manner.

12. A method for manufacturing an assembly for a rotor shaft, wherein, on a forged attachment flange , which comprises a base plate, a coolant distribution body is applied according to an additive manufacturing method at least in some regions, wherein the additively manufactured coolant distribution body is arranged on the base plate of the forged attachment flange in a radially centered manner.

13. The rotor shaft according to claim 5, wherein at least some of the coolant channels are in fluidic connection with a cooling channel of the attachment flange.
